(19) United States
(12) Patent Application Publication
(10) Pub. No.: US 2009/0044004 A1
(43) Pub. Date: Feb. 12, 2009

(54) METHOD FOR OPERATING COMPUTER AND OPERATING SYSTEM THEREOF

(75) Inventors: Jung-Chung Wang, Taipei (TW); Chia-Mei Hung, Taipei (TW); Chia-Hui Han, Taipei (TW); Jun-Jie Liao, Taipei (TW); Chih-Yi Chen, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ASUSTeK COMPUTER INC., Taipei (TW)

(21) Appl. No.: 12/185,823

(22) Filed: Aug. 5, 2008

(30) Foreign Application Priority Data
Aug. 10, 2007 (TW) 96129602

(51) Int. Cl. G06F 1/24; G06F 9/44

(52) U.S. Cl. 713/100; 719/328

(57) ABSTRACT

A method for operating a computer having at least an operating system is provided. The method includes the steps of building a plurality of working platforms each of which has a corresponding user interface in the operating system and providing at least a calling link for each working platform to allow each working platform to have at least a piece of usable application software. In addition, a platform selected sub-interface is provided to receive the input of a user. Thus, the corresponding working platform may be called according to the input of the user to allow the user to operate the computer under the user interface corresponding to the selected working platform.

### CROSS-REFERENCE TO RELATED APPLICATION

This application claims the priority benefit of Taiwan application serial no. 96129602, filed on Aug. 10, 2007. The entirety of the above-mentioned patent application is hereby incorporated by reference herein and made a part of this specification.

### BACKGROUND OF THE INVENTION

1. Field of the Invention

The invention relates to a method for operating a computer and, more particularly, to a method for operating a computer having a plurality of working platforms.

2. Description of the Related Art

As we all know, an operating system is a program managing the hardware and software resource of the computer, and it also is the core of the computer. The operating system is in charge of basic works such as managing and configuring network and managing the file system, and it also provides an operating interface for allowing a user to interact with the system.

As for the conventional operating systems, they mostly provide graphic user interfaces for users to operate. Compared with the traditional DOS interface, the graphic user interface simplifies the operation for the operating system, and most users may learn to use the operating system quickly. However, different operating program is used in different operating mode. Therefore, when a user is used to the graphic user interface of an operating system, if the operating system is changed, he often cannot learn to use the new quickly.

In addition, the conventional operating system only has a single graphic user interface. Therefore, if a different graphic user interface needs to be used to operate the computer, the computer needs to log out the used operating system, and it needs to be rebooted to log in another operating system. Thus, a different graphic user interface may be used to operate the computer. From the above, the process wastes the time, and different operating systems needs to be installed in the computer, which is inconvenient.

### BRIEF SUMMARY OF THE INVENTION

One objective of the invention is to provide a method for operating the computer which allows a user to operate the computer according to the user interface that he is used to.

Another objective of the invention is to provide an operating system for the computer, and the operating system provides various user interfaces for users to operate.

The invention provides a method for operating a computer having at least an operating system. The operating method of the invention includes the following steps. A plurality of working platforms are built in the operating system, and each working platform has a corresponding user interface. In addition, at least a calling link is provided for each working platform to allow each working platform to have at least one piece of usable application software. Furthermore, in the invention, a platform selected sub-interface is provided to receive an input of a user. Thus, a corresponding working platform may be called according to the input of the user to allow the user to operate the computer under the user interface corresponding to the selected working platform.

In one embodiment of the invention, the step of setting the calling link of each working platform includes the step of providing a preset sub-interface in the user interface of the used working platform to receive the input of the user. Thus, in embodiment of the invention, according to the input of the user, a calling link may be added to the used working platform to link with new application software, or the calling link existing in the used working platform may be removed. When a user adds a new calling link, a shortcut item may be provided in the user interface of the used working platform. Thus, when the user enables the shortcut item, the working platform may call and execute the corresponding application program via the calling link.

The invention further provides a method for operating a computer having a plurality of operating systems. The method for operating the computer includes the step of providing a plurality of working platform in one of the operating systems, and each working platform has a corresponding user interface and usable application software. Furthermore, the working platform may be switched according to the input of a user to allow the user to operate the computer under different user interface.

In addition, in the invention, an operating system selected sub-interface may further be provided to allow a user to select to load another operating system to the computer to operate the computer. When the user identifies that he wants to switch to another operating system, the computer logs out the used operating system and is rebooted. In addition, the operating system selected by the user is loaded, and the computer operates under the new operating system.

The invention provides an operating system of a computer. The operating system includes a core unit, a plurality of application software units and a plurality of working platforms. The core unit is coupled to the application software units and the working platforms. The core unit selects one of the working platforms according to the input of a user to allow the user to operate the computer under the user interface corresponding to the selected working platform, and part of the application software units may be used.

From the above, in the invention, a plurality of working platforms may be built under an operating system, and each working platform has a different user interface. Therefore, a user may operate the computer under a user interface that the user is used to.

These and other features, aspects, and advantages of the present invention will become better understood with regard to the following description, appended claims, and accompanying drawings.

### BRIEF DESCRIPTION OF THE DRAWINGS

FIG. 1 is a system block diagram showing a computer.

FIG. 2 is a flow chart showing the steps of the method for operating a computer according to a preferred embodiment of the invention.

FIG. 3 is a configuration diagram showing an operating system according to a preferred embodiment of the invention.

FIG. 4A is a schematic diagram showing a paging picture graphic user interface according to the first embodiment of the invention.

FIG. 4B is a tree cataloged graphic user interface according to the second embodiment of the invention.

FIG. 5 is a flow chart showing steps of setting a calling link according to a preferred embodiment of the invention.

FIG. 6 is a flow chart showing steps of switching operating systems according to a preferred embodiment of the invention.

### DETAILED DESCRIPTION OF THE EMBODIMENTS

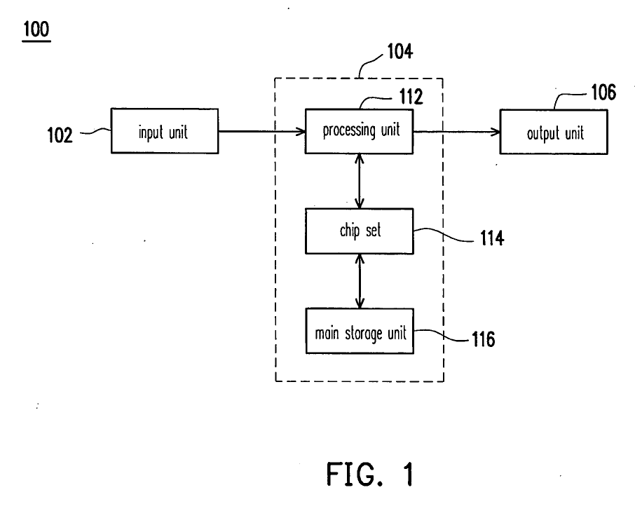

FIG. 1 is a system block diagram showing a computer. As shown in FIG. 1, the computer 100 may include an input unit 102, a main system module 104 and an output unit 106. Generally speaking, the input unit 102 may be a device such as a keyboard or a mouse. The output unit 106 may be a display. The output of the input unit 102 is coupled to the main system module 104, and the output of the main system module 104 is coupled to the output unit 106.

The main system module 104 may include a processing unit 112, a chip set 114 and a main storage unit 116. The processing unit 112 may receive the output of the input unit 102 to process it and output the processing result to the output unit 106. The processing unit 112 may be coupled to the main storage unit 116 via the chip set 114. In the embodiment, the main storage unit 116 may be a hard disk or a nonvolatile memory. Usually, at least an operating system may be installed in the main storage unit 116. When the computer 100 is booted, the processing unit 112 may load the operating system to the main storage unit 116 via the chip set 114 to allow the computer 100 to work normally.

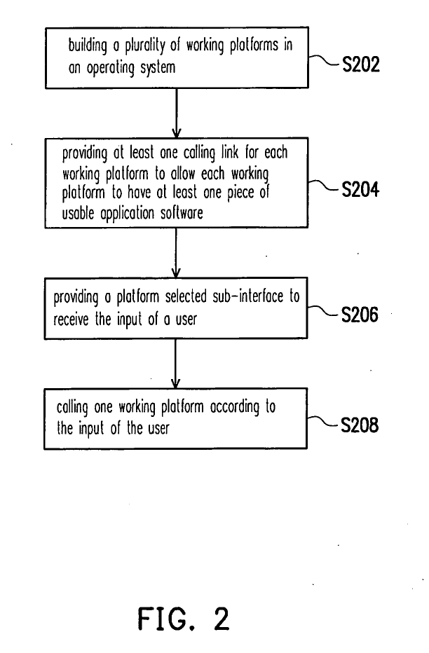

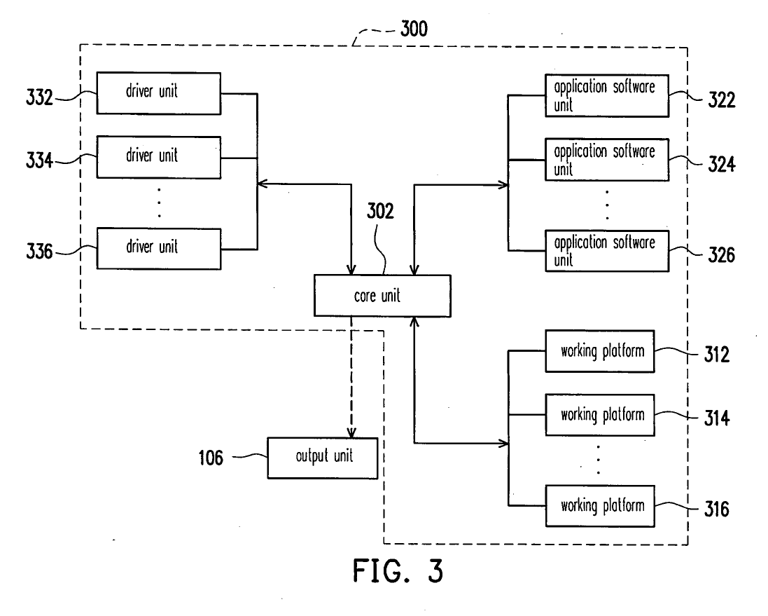

FIG. 2 is a flow chart showing the steps of a method for operating a computer according to a preferred embodiment of the invention. FIG. 3 is a configuration diagram showing an operating system according to a preferred embodiment of the invention. As shown in FIG. 2 and FIG. 3, the operating system 300 may be installed to, for example, the main storage unit 116 shown in FIG. 1. As stated by the step S202, a plurality of working platforms such as the working platforms 312, 314 and 316 may be built in the operating system 300.

Besides the working platforms 312, 314 and 316, the operating system 300 also may include a core unit 302, a plurality of application software units (such as the application software units 322, 324 and 326) and a plurality of driver units (such as the driver units 332, 334 and 336). The core unit 302 may be coupled to the working platforms 312, 314 and 316, the application software units 322, 324 and 326 and the driver units 332, 334 and 336. The driver units 332, 334 and 336 are used to drive the hardware of the compute device 300 or the peripheral devices such as the output unit 106.

Each working platform (or called working environment) 312, 314 or 316 of the operating system 300 may have a different user interface. Each working platform 312, 314 or 316 may be linked with one of the application software units 322, 324 and 326 via at least a calling link, as stated by the step S204. Thus, when a user operates the computer 300 under the user interface provided by one working platform, he may make the application software unit linked with the working platform executed. In the embodiment, the calling link of each working platform may be set in the core unit 302.

In addition, the core unit 302 of the embodiment also may provide a platform selected sub-interface to receive the input of the user, as stated by the step S206. Thus, the core unit 302 may call one working platform according to the input of the user, and the display unit 106 displays the user interface corresponding to the selected working platform. Thus, a user may select a user interface to which he is used to operate the computer. The user interface provided by the working platform is described hereinbelow with some embodiments.

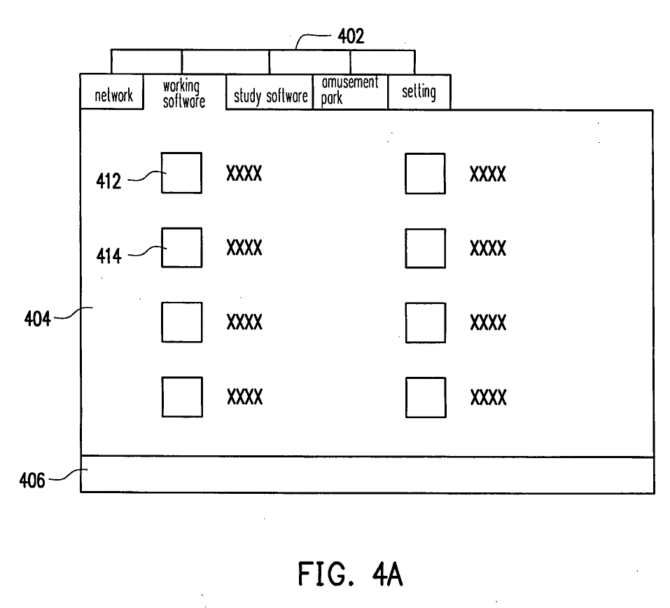

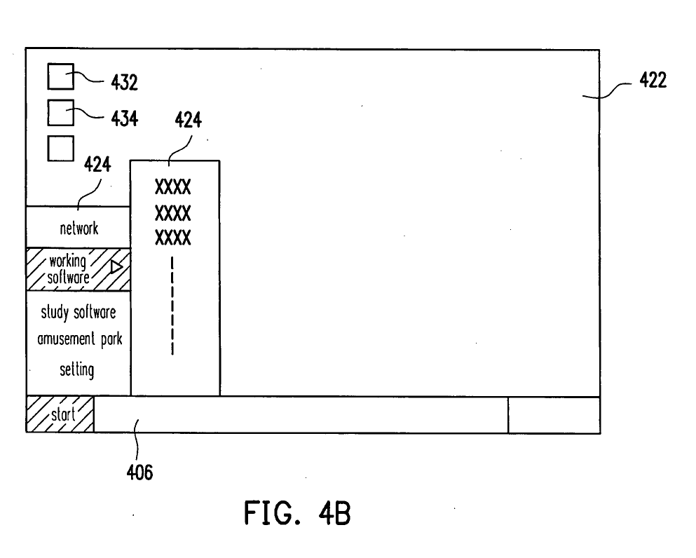

FIG. 4A is a schematic diagram showing a paging picture graphic user interface according to the first embodiment of the invention. As shown in FIG. 4A, in the embodiment, the user interface may include label areas 402, desktop areas 404 and a working list area 406. Each label area 402 corresponds to different desktop area 404. In each desktop area 404, the shortcut items such as the shortcut items 412 and 414 of the linked application software may be displayed. The application software with different property may be displayed in the desktop area 404 that different label area 402 corresponds to. In the embodiment, when a shortcut item (such as the shortcut item 412) is enabled by a user, the working platform corresponding to the user interface may call and execute the corresponding application software.

FIG. 4B is a schematic diagram showing a tree cataloged graphic user interface according to the second embodiment of the invention. As shown in FIG. 4B, the user interface in the embodiment includes desktop areas 422, catalog areas 424 and a working list area 426. The catalog area 424 may display the application software which may be used to select by a user. In addition, on the desktop area 422, a plurality of shortcut items such as the shortcut items 432 and 434 also may be displayed.

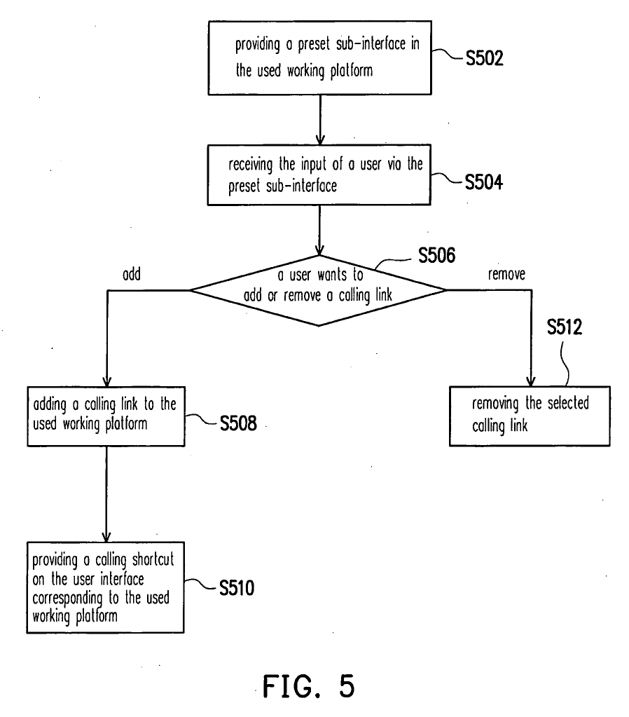

In the embodiment, the application software that may be used by each working platform may be different or partially same. FIG. 5 is a flow chart showing the steps of setting a calling link according to a preferred embodiment of the invention. As shown in FIG. 5, a preset sub-interface may be provided in each user interface corresponding to each working platform, as stated by the step S502. For example, in the user interface shown in FIG. 4A, a preset sub-interface may be provided in the desktop area corresponding to the label “setting” to allow a user to select the application software that may be used by the user interface of the used working platform. Thus, as stated by the step S504, the input of the user may be received via the preset sub-interface. Then, as stated by the step S506, whether a calling link needs to be added or removed is determined.

Assuming that a piece of usable application software needs to be added to the used user interface, as stated by the step S508, a calling link is added to the used working platform. It makes the used working platform link to the corresponding application software. In addition, in the embodiment, as stated by step S510, a shortcut item is provided for the user interface corresponding to the used working platform. Correspondingly, if a user does not want to use some application software in the used user interface, as stated by the step S512, the calling link between the application software which needs to be disabled and the used working platform is removed.

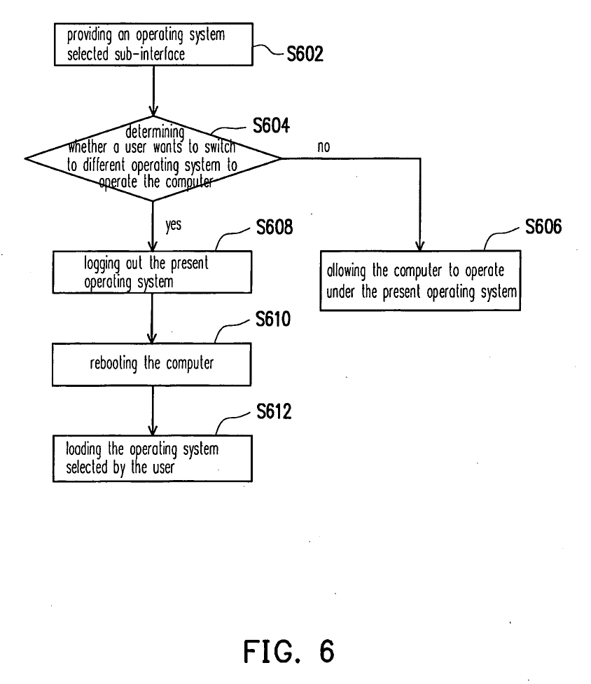

In some embodiments, a plurality of operating systems may be installed in the main storage unit 116 in FIG. 1. Therefore, in the embodiment of the invention, not only different user interfaces may be selected according to the input of the user, and different operating systems also may be switched to work. FIG. 6 is a flow chart showing the steps of switching operating systems according to one preferred embodiment of the invention.

As shown in FIG. 6, in the embodiment, as stated by the step S602, an operating system selected sub-interface is provided for a user to select to switch the operating systems. When a user enables the operating system selected sub-interface, a dialogue box may pop up to execute the step S604. That is, whether the user identifies that he wants to switch to different operating system is determined. If the user does not want to switch to another operating system (“no” in the step S604), as stated by the step S606, the computer continues working under the present operating system.

On the contrary, if the user actually wants to switch to different operating system to operate the computer (“yes” in the step S604), the step S608 may be executed. That is, the computer logs out the present operating system and is rebooted as stated by the step S610. After the computer is rebooted, as stated by the step S612, the operating system selected by the user is loaded.

In some embodiments of the invention, whether the application software in the operating system has errors or whether the versions of the driver units of the hardware need to be updated may be checked. If it is checked that the application software has errors, or the version of one driver unit is old, a database may be linked to update the application software unit or the driver unit.

In addition, in some embodiment of the invention, the supplier of the computer may set up a service center, and the data of the database may be updated periodically. Thus, the computer may normally work.

To sum up, in the invention, the working platforms with different user interfaces are provided. Therefore, a user may operate the computer under a needed working environment according to his custom.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A method for operating a computer having an operating system, the method comprising the steps of:
building a plurality of working platforms having a corresponding user interface, respectively, in the operating system;
providing a calling link for each working platform to allow each working platform to have a usable application software;
providing a platform selected sub-interface to receive an input of a user; and
calling the corresponding working platform according to the input of the user to allow the user to operate the computer under the user interface corresponding to the selected working platform.

2. The method according to claim 1, wherein the user interface comprises a paging picture graphic user interface.

3. The method according to claim 1, wherein the user interface comprises a tree cataloged graphic user interface.

4. The method according to claim 1, wherein the step of setting the calling link of each working platform comprises the steps of:
providing a preset sub-interface in the used working platform to receive an input of the user;
adding a calling link to the used working platform according to the input of the user to link with a piece of new application software to allow the usable application software to be added to the working platform; and
providing a shortcut item on the user interface corresponding to the used working platform to allow the corresponding application software to be executed when the user enables the shortcut item.

5. The method according to claim 4, wherein the step of setting the calling link of each working platform further comprises the step of removing the selected calling link according to the operation of the user.

6. The method according to claim 1, wherein the application software linked with each working platform is different.

7. The method according to claim 1, wherein part of the application software linked with each working platform is same.

8. A method for operating a computer having a plurality of operating systems, the method comprising the steps of:
providing a plurality of working platforms in one of the operating systems, wherein each working platform has a corresponding user interface and a piece of usable application software; and
switching the working platforms according to an input of a user to allow the user to operate the computer under the different user interface.

9. The method according to claim 8, wherein the user interface comprises a paging picture graphic user interface.

10. The method according to claim 8, wherein the user interface comprises a tree cataloged graphic user interface.

11. The method according to claim 8 further comprising the steps of:
providing a selected interface for the user to select to load another operating system to the computer;
when the user identifies that he wants to switch to another operating system, logging out the used operating system;
rebooting the computer; and
loading the operating system selected by the user to allow the computer to operate under the new operating system.

12. An operating system of a computer, comprising:
a core unit;
a plurality of application software units coupled to the core unit; and
a plurality of working platforms coupled to the core unit and each of which has a corresponding user interface;
wherein the core unit selects one of the working platforms according to an input of a user to allow the user to operate the computer under the user interface corresponding to the selected working platform and to use some of the application software units.

13. The operating system according to claim 12, further comprising a plurality of driver units for driving a plurality of hardware in the computer and peripheral devices connected to the computer, respectively.

14. The operating system according to claim 12, wherein the user interface comprises a paging picture graphic user interface.

15. The operating system according to claim 12, wherein the user interface comprises a tree cataloged graphic user interface.
